(19) United States
(12) Patent Application Publication
(10) Pub. No.: US 2023/0029022 A1
(43) Pub. Date: Jan. 26, 2023

(54) GARMENT FOR THE UPPER BODY

(71) Applicant: POLEKA SHIRT PROJECT, SL, Alicante (ES)

(72) Inventor: Jaime JAIME DE MANUEL PEÑA, El Campello (ES)

(73) Assignee: POLEKA SHIRT PROJECT, SL, Alicante (ES)

(21) Appl. No.: 17/791,205

(22) PCT Filed: Jan. 13, 2021
(86) PCT No.: PCT/ES2021/070010

§ 371 Date: Jul. 6, 2022

(30) Foreign Application Priority Data
Jan. 16, 2020 (ES) U202030051

(51) Int. Cl. A41B 1/08

(52) U.S. Cl. CPC A41B 1/08

(57) ABSTRACT

The invention relates to an upper body garment, comprising a body (1), characterised by having the cut and the fabrics used to make a polo shirt, to which a collar (5), two sleeves (7) and two cuffs (8) are permanently attached, characterised by having the cut and the fabrics used to make a shirt.

### TECHNICAL FIELD

The present invention is applied within the textile industry, particularly in the sector dedicated to the manufacture of clothing for everyday life, although it can also be applied in the industry of clothing for the practice of sports such as horse riding, sailing, golf, and also in the manufacture of school, academic and corporate uniforms.

### BACKGROUND OF THE INVENTION

From 1960 onwards, a piece of clothing for the upper body appeared, which was used to uniform the participants in tournaments of a sport called “polo”. This garment was known as “polo shirt” because of this use, a name that has remained to this day.

Nowadays, a polo shirt is a garment made of pique or plain knit fabric that has the same shape as a t-shirt, but also has a collar made of the same fabric, without a band, with a front opening with two or three buttons and can have a chest pocket and even replace the buttons with any other type of textile fastener. This type of garment extends below the waist and is designed to be worn over the trousers. The polo is also made in long sleeves, with ribbed cuffs, with or without elastane.

The piqué knit stands out for being a fabric that allows body moisture to pass through to the outside, keeping the body dry and giving a sensation of freshness. This is achieved by fractionating twelve in twelve yarns, usually cotton, with or without elastane, which is characterized by the fact that half of the yarns raised from each section switch alternately in each pass.

Plain stitch is also known as jersey stitch, it is less rigid than pique stitch and is used to make comfortable clothes such as T-shirts, leggings, skirts, dresses, etc. Cotton is normally used, with or without elastane, which makes it a fresh, lightweight and very comfortable garment to wear.

On the other hand, a shirt is made with shirt cloth or shirt fabrics, more formal and elegant, among which are the Madras, Poplin, Oxford, Royal Oxford, Batiste, Denim, Pinpoint, Twill, Ribbed Twill or Herringbone, among others. Each of them has its own particularity, for example the Poplin is the finest and freshest of all; the Twill has a diagonal texture in the fabric, is denser in structure and wrinkles less than the Poplin; the Oxford has a rustic texture like a basket; the Pinpoint is a variation of the Oxford formed with thinner yarns, creating a lighter fabric; and the Herringbone is a variation of the Twill in which the pattern of the horizontal yarns changes creating a Herringbone pattern. Cotton, with or without elastane, is usually used for making shirt fabrics.

In nowadays fashion, long-sleeve polos are generally regarded by consumers as more informal than shirts, but more comfortable than shirts. This is because, while polos and shirts have a simple cut that makes them comfortable, shirts have a full front opening, which goes from the collar to the bottom of the shirt and generally uses buttons as a fastening system, although shirts with other textile fastening systems are known, for instance hooks. In addition, they have a yoke on the back that gives width to the body of the garment, and also a pleat to correct the fall of the garment on the back, which gives it an elegant look, either alone, rolled up, with a jacket or a jacket. The sleeves of a shirt have an opening at the bottom of the sleeve with a cuff on the back aligned with the elbow, and are generally closed with at least one button, which allows the cuff to be folded and the sleeves to be rolled up, maintaining all their elegance on one side, while on the other side such sleeves are easy to roll up and are very comfortable to wear thanks to such openings, unlike the ribbed cuffs of a long-sleeved polo shirt, which are uncomfortable.

Last, the collar of a formal, elegant shirt differs from a polo shirt in that it has a band and also has a fastening element, generally a button, while the collar of a polo shirt lacks both. The band is the piece that joins the collar to the neck line, which is raised with respect to the garment and is what keeps the set of pieces or leaves that form the collar upright. Among the different types of collars we find, among others, the Italian collar, the American collar, the Mao collar, the English collar, the Opera collar, the Cutaway collar, etc. and all the variants of these, which adapt to the fashion trends of each moment. The Mao or ribbon collar is an exception to the rest of the collars, as it is made of polyester.

Despite its lesser comfort, shirts do dress people of all ages and sexes, not only in the office, in schools, universities, or to attend formal events or certain ceremonies as a symbol of elegance, but also, nowadays, the shirt is worn outside the pants in a sporty or casual way, in moments of leisure and entertainment, being lately very used by the youth for this purpose.

Those who prioritize comfort over elegance, opt for polo shirts and combine them with jackets or blazers for a more elegant effect. However, wearing a jacket or blazer over a short-sleeved polo shirt produces an unsightly effect by revealing the person's wrists under the jacket, covered with hair in the case of men.

On the other hand, long-sleeved polo shirts have an informal look because the cuffs are usually ribbed; and when the sleeves and cuffs have a shirt opening, the pique or plain knit fabric does not give it an uniform appearance and is not as elegant as the cuffs of a formal shirt as the fabrics described herein. Similarly, pique or plain knit fabrics in long sleeves, when rolled up, do not look elegant, but informal. In the case of plain knitwear, like that of a T-shirt, the polo shirt is made with a ribbed cuff, so when rolled up it has many wrinkles. And when the cuff has a shirt opening, it never has the elegance of a shirt with more formal fabrics.

Another disadvantage of long-sleeved polo shirts is that they are made of pique knitted fabric, so they have more friction than a shirt made of any other type of fabric mentioned for shirts. And because of this, it is more difficult to put the jacket or blazer on.

Likewise, the use of jackets and blazers on long-sleeved polos considerably reduces the comfort of the arms since jackets or blazers are made with an inner lining designed to accommodate the sleeves of a shirt, with greater smoothness and less friction than the fabric used for polos. And, unlike a person's bust, the arms are in continuous movement, so this use is more uncomfortable than when the jacket or jacket is worn with a shirt.

This problem of discomfort in the sleeves also occurs with the use of sweaters with jackets or blazers, and therefore an option available on the market is to wear cotton vests that leave the sleeves of the shirts free, allowing the jacket and blazer to be worn in total comfort. However, when wearing vests or sweaters, the shirt cannot be worn on the outside with a casual look, but it gives it a careless and not at all elegant look. Another disadvantage is that the vests do not adapt perfectly to the shirt, leaving visible the wrinkles of the shirts under the vest that also translates into discomfort.

A disadvantage of the shirts is that, because they never fit perfectly on all body types due to the different morphology of people, the fabric that covers the torso is subjected to irregular stretching that all converge on the closing line of the shirt, and with more intensity in the buttonholes where the buttons are inserted, which causes wrinkles and small openings that reveal the body of the person wearing the shirt, resulting in undesirable situations such as partially showing a woman's bra, or the belly in adult men. Therefore, when a person is forced to wear a shirt at work for eight hours, these discomforts can become very annoying.

There are also shirts made exclusively from pique knitwear, which are used in summertime as a cool alternative to linen, as it wrinkles less than linen. However, the use of this fabric in the shirts reduces its elegance due to the rigidity of the pique fabric which does not fit well with the total opening, which is also made with a button-closure system, so on one hand they do not have the elegance of the shirts with more formal and elegant shirt fabrics, nor do they have the comfort of a long-sleeved polo shirt because they are made following the cutting patterns used on shirts.

There are also shirts with a polo-type collar opening, with a three-button closure, instead of the classic “top-to-bottom” front opening with full button closure, and which is marketed under the name of polo-shirt. However, the main disadvantage of polo shirts is that, by combining the type of cut typical of polo shirts and shirt cloth, they produce the visual effect of looking like a blouse, since polo shirts are made to be worn pulled out and below the waist, so the aesthetic result is not good and therefore they are less in demand by the consumer public.

Due to the increasing level of demand for an elegant appearance at work, and the difficulty of reconciling work, family and leisure, most consumers demand versatile clothing that can be worn both in the social, work, professional and family spheres. On the other hand, workers in the service sector such as restaurants or in supermarkets who are facing the consumer, are forced to prioritize comfort over aesthetics, and therefore wear uniforms that are not very elegant; likewise, students who wear their school uniforms five days a week and on Saturdays when they participate in sports events, demand greater comfort, without giving up formalism and elegance.

To date, there is no garment that combines the elegance of a shirt with the comfort of a polo shirt. The present invention allows to dress in a comfortable, classy and elegant way, which is achieved thanks to the combination of the fabrics and cutting patterns typical of a polo shirt and the cutting patterns and fabrics of the collar, sleeves and cuffs of a formal shirt, so that on one hand the cutting pattern typical of a polo shirt is used, which is simpler and more comfortable, for the bust of the garment, and with more comfortable fabrics, such as piqué or plain knit, made with cotton yarn with or without elastane; and on the other hand, the cutting patterns typical of a shirt are used on the collar, sleeves and cuffs, with more elegant and formal shirt fabrics made with cotton yarn with or without elastane, which in turn are more comfortable fabrics when the sleeves are rolled up or a jacket or jacket is worn. The combination of the two types of fabrics allows for varying the grammages of each combined part, the polo part (bust or body) and the shirt parts (collar, sleeves and cuffs), so that the bust or body can be given different grammages from those of the sleeves, achieving for example a vest effect, but totally comfortable, when the grammage of the body fabric is greater than that of the sleeves, cuffs and collar.

### DETAILED DESCRIPTION

The present invention refers to a garment, namely one of those for the upper body and intended to combine the comfort of a polo shirt and the elegance of a formal shirt, which is achieved by combining the body of a polo shirt without the collar and sleeves, maintaining the front opening and taking advantage of its simple cutting pattern and the characteristic fabrics of a polo shirt that give it comfort, to which the collar, sleeves and cuffs are sewn, with the cutting pattern and fabrics characteristic of a formal shirt that give an elegant look and greater comfort when the sleeves are rolled up.

The fabrics used in the various parts which make up the present invention may be made, uniformly for the whole garment, from cotton yarn with or without elastane. Alternatively, the proposed invention may also combine fabrics made entirely of cotton with fabrics made of cotton with elastane.

Specifically, the invention refers to a garment for the torso and arms made of cotton yarn with or without elastane, comprising a body which has the characteristics of a polo shirt, for both the cutting pattern and the fabric which is pique knit or plain knit, which has a front opening with any type of closure means used for clothing, which can be visible or concealed by means of a flap, to which a shirt collar is added, preferably with a band, for example an Italian collar, and the sleeves and cuffs of a formal shirt are also added comprising shirt openings with the possibility of closure by means of at least one button or by any other means known for clothing, which may be visible or concealed, with or without plackets, characterized by the fact that both the cutting patterns and the fabrics used in the manufacture of said collars, sleeves and cuffs are those used in formal shirts, with or without elastane, for example, the Oxford type, which is a perfect combination of the comfort of a polo shirt and the elegance of a formal shirt, giving it both comfort and a new aesthetic effect, and giving the user multiple possibilities when dressing up with it, whether alone, with sleeves rolled up, with a jacket or blazer, with or without a tie.

In an embodiment of the invention, it is possible that the openings in cuffs have eyelets for the placement of an accessory element of textile closure that is not permanently attached to the garment, such as cuff links.

In another embodiment of the invention, the buttons which act as a closing element in the sleeve openings are hidden under a flap.

In another embodiment of the invention, the shirt collar does not have a band, as it happens with the Mao collar, or because it has been made with a single piece achieving an aesthetic effect typical of a formal or elegant shirt.

The body can be combined with collars, sleeves and cuffs of all formal or elegant shirt styles, both current and those appearing in the world of fashion, maintaining the essential character that makes this garment a novelty and that provides a solution to the problems raised in the background of the invention.

### BRIEF DESCRIPTION OF THE DRAWINGS

To complement the description that is being made and in order to help for a better understanding of the characteristics of the invention, according to an example of practical embodiment thereof, a set of drawings is included as an integral part of this Utility Model where, by way of illustration and not limitation, the following is shown:

FIG. 1.- Shows a front view of the garment which, according to a preferred embodiment of the invention, comprises the body of a polo shirt with plain knit fabric with a composition of 95% cotton and 5% elastane, with a front opening with two button closure with placket, to which a shirt collar with a band is attached; also attached to the body of the polo shirt are shirt sleeves and cuffs with sleeve plackets or openings with two buttons that are permanently sewn an means of closure.

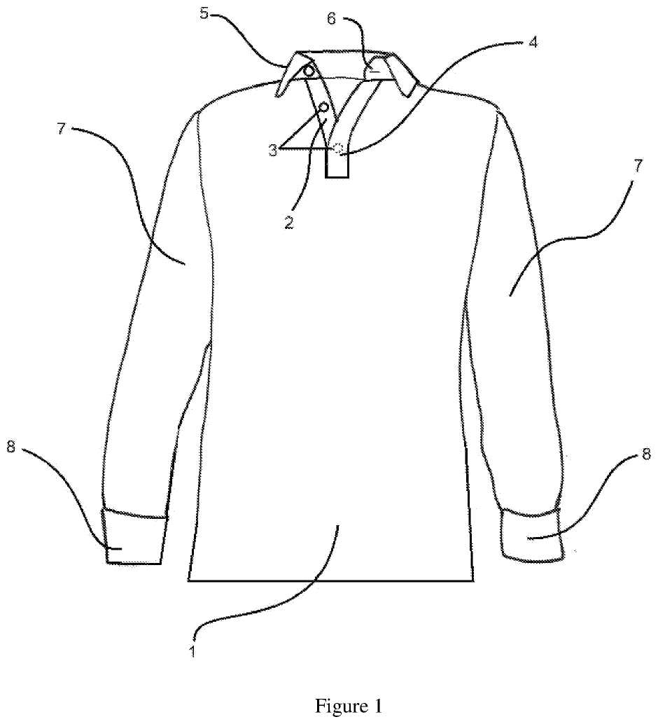

FIG. 2.- Shows a rear view of the garment according to a preferred embodiment, comprising a polo body with plain knit fabric with 95% cotton and 5% elastane, with a front opening with two button closure with placket, to which a shirt collar with a band is attached; also attached to the body of the polo shirt are shirt sleeves and cuffs with sleeve plackets or openings with two buttons that are permanently sewn an means of closure.

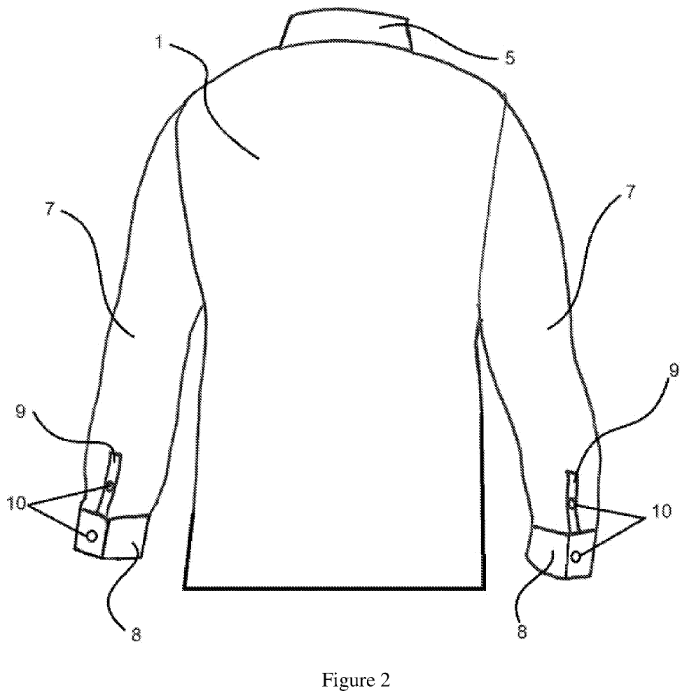

### PREFERRED EMBODIMENT OF THE INVENTION

In view of the outlined drawings, a preferred embodiment of the invention can be described as an upper body garment comprising a polo-shirt cut body 1 made of plain knit fabric with 95% cotton yarn and 5% elastane, which has a front opening 2 with closure means 3 comprising at least one button, and a flap 4, to which is added an Italian type shirt collar 5 with band 6 comprising textile closure means by way of a button, a pair of shirt sleeves 7 and a pair of shirt cuffs 8 makers with opening in sleeves and cuffs 9 with clothing closure means 10 preferably by at least two buttons, all made of Oxford-type fabric, with 95% cotton yarn and 5% elastane.

The invention has been described according to this text and set of figures for a preferred embodiment thereof, but it may incorporate accessory details without affecting the essential nature of the invention, including the means of fastening or clothing closure on the collar, which could be replaced suitably by others that are technically equivalent, and varying the type and composition of the yarn used, without departing from the scope defined by the claims that are included below.

1-14. (canceled)

15. An upper body garment, comprising a body characterized for having the cutting pattern and the fabrics used to make a polo shirt, to which a collar, two sleeves and two cuffs are permanently attached, characterized for having the cutting pattern and fabrics used to make a shirt.

16. The upper body garment, according to claim 15, characterized by the fact that the polo body has an opening in the front.

17. The upper body garment, according to claim 16, characterized by the fact that the opening comprises at least a button for clothing closure.

18. The upper body garment, according to claim 17, characterized by the fact that the button of the opening is hidden behind a flap.

19. The upper body garment, according to claim 15, characterized by a shirt collar comprising a collar band.

20. The upper body garment, according to claim 15, characterized because the fabrics used are made entirely of cotton yarn.

21. The upper body garment, according to claim 15, characterized by the fact that the fabrics used are made of cotton yarn and elastane.

22. The upper body garment, according to claim 15, characterized by the fact that the fabric of the body is made of cotton yarn and elastane and the fabric of the collar, sleeves and cuffs are made entirely of cotton yam.

23. The upper body garment, according to claim 15, characterized by the fact that the fabric of the body is made entirely of cotton yarn and the fabric of the collar, sleeves and cuffs are made of cotton yarn and elastane.

24. The upper body garment, according to claim 15, characterized by the fact that the sleeves and cuffs have an opening.

25. The upper body garment, according to claim 24, characterized by sleeves and cuffs having an opening with at least one clothing closure element.

26. The upper body garment, according to claim 25, characterized by the textile fastening system of the opening is concealed.

27. The upper body garment, according to claim 24, characterized by cuffs comprise eyelets for the attachment of clothing closure elements not attached to the garment.
